(19) United States
(12) Patent Application Publication
(10) Pub. No.: US 2026/0111392 A1
(43) Pub. Date: Apr. 23, 2026

(54) REDUCE RUNTIME OF ADD-ON CODING DURING ARCHIVING

(71) Applicant: SAP SE, Walldorf (DE)

(72) Inventor: Horst Schaude, Kraichtal (DE)

(21) Appl. No.: 18/921,982

(22) Filed: Oct. 21, 2024

(51) Int. Cl. G06F 16/11

(52) U.S. Cl. CPC G06F 16/113

(57) ABSTRACT

In an example embodiment, a specialized archiving add-on code check is performed when an object status has been changed to a status indicating that the object is being archived. This archiving add-on code check blocks execution of any code within the object that is set to trigger (execute) from the change in the status or while the status remains in this state. Once archiving has been completed, the status of the object is changed to “archived” so that it may be deleted. The archiving add-on code check then makes an exception for any code that is set to trigger upon deletion of an object. All other code remains blocked from execution, but while the status of the object is set at “archived” the code that is set to trigger upon deletion of an object is permitted to be executed.

### BACKGROUND

Data archiving is the process of moving data that is no longer actively used to a separate storage device for long-term retention. Data may be archived for several reasons, such as for regulatory compliance. Data archives may be indexed and have search capabilities so that archived data can be located and retrieved.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is an example network diagram illustrating a system, in accordance with an example embodiment.

FIG. 2 is a block diagram illustrating an example archive access system, in accordance with an example embodiment.

FIG. 3 is a flowchart illustrating an example method, in accordance with an example embodiment.

FIG. 4 is a block diagram of an example computer system on which methodologies described herein can be executed.

### DETAILED DESCRIPTION

Example methods and systems of implementing access control for archived objects are disclosed. In the following description, for purposes of explanation, numerous specific details are set forth in order to provide a thorough understanding of example embodiments. It will be evident, however, to one skilled in the art that the present embodiments can be practiced without these specific details.

An object is a self-contained software entity that comprises data and functions to manipulate data. Data of an object may contain information regarding any personal or private data access restrictions that should be applied to the data. The object format may contain special sections that can be interpreted by an access control framework to determine these data access restrictions. Data that is in a production system is typically available in the format of the object. Therefore, an access control process can be called to verify whether a user has access to the data in the production system.

It is now common for a cloud platform to provide archiving services for data stored by the cloud platform, or even for data stored on-premise at customer locations. Additionally, clients are able to add their own fields/code to objects controlled by the cloud platform. One common use for such fields is to provide code to perform various actions whenever the object changes. For example, a customer may add custom code that indicates that whenever an object changes, a remote call is made to an external service to obtain an updated price quote for an item. This code may be provided in, for example, Advanced Business Scripting Language (ABSL). ABSL is an offshoot of C++.

A technical problem exists, however, when objects containing such code are run through an archiving process. Specifically, when an object is to be archived a field is set, changing the status of the object to “InProcess”. This helps ensure that the object will not be used in any new software process. It essentially locks the object from being used in ordinary software processes unrelated to the archiving. Once the object has been archived, the object is then deleted. Nevertheless, these changes to the object status field are technically changing the object, and thus any user-specified code for the object is triggered, just as if the change to the object were more substantive (e.g., a SKU number for an item changes).

This can cause significant time delays, as the user-specified code will often call an external service, which may take time to respond. In essence, the presence of the user-specified code for the object acts as a back door by which a time-consuming software process is run even though all other ordinary software processes on the object being archived have been locked.

To further complicate matters, in some instances the user-specified code is important to run while in others it is not. For example, if the user-specified code is designed to be triggered upon deletion of the object, then the underlying process of the user-specified code is likely some process that needs to be performed whenever the object is deleted, whether due to archiving or not.

In an example embodiment, a specialized archiving add-on code check is performed when an object status has been changed to a status indicating that the object is being archived. This archiving add-on code check blocks execution of any code within the object that is set to trigger (execute) from the change in the status or while the status remains in this state. Once archiving has been completed, the status of the object is changed to “archived” so that it may be deleted. The archiving add-on code check then makes an exception for any code that is set to trigger upon deletion of an object. All other code remains blocked from execution, but while the status of the object is set at “archived” the code that is set to trigger upon deletion of an object is permitted to be executed.

Thus, while the object is being archived, any add-on code associated with the object is blocked from execution. Then, once the object has been archived, most add-on code associated with the object is blocked, with the exception of add-on code that is designed to trigger based on deletion of the object. The result is a significant reduction in the time it takes to perform archiving, as unnecessary external calls are blocked during the archiving process.

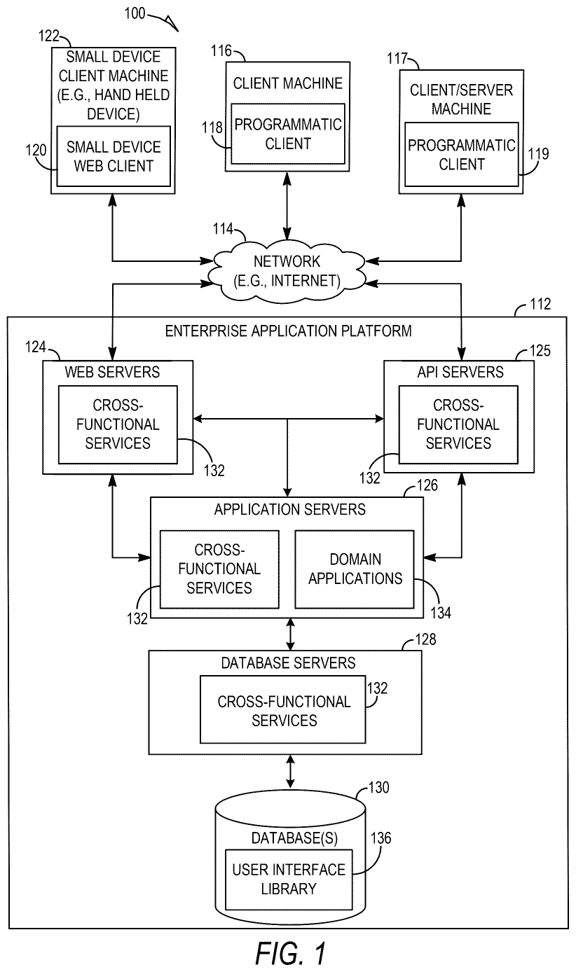

FIG. 1 is an example network diagram illustrating a system 100, in accordance with an example embodiment. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The web servers 124, API servers 125, application servers 126, and database servers 128 can host cross-functional services 132. The cross-functional services 132 can include relational database modules to provide support services for access to the database(s) 130, which includes a user interface library 136. The application servers 126 can further host domain applications 134. The web servers 124 and the API servers 125 may be combined.

The cross-functional services 132 provide services to users and processes that utilize the enterprise application platform 112. For instance, the cross-functional services 132 can provide portal services (e.g., web services), database services, and connectivity to the domain applications 134 for users that operate the client machine 116, the client/server machine 117, and the small device client machine 122. In addition, the cross-functional services 132 can provide an environment for delivering enhancements to existing applications and for integrating third-party and legacy applications with existing cross-functional services 132 and domain applications 134. In some example embodiments, the system 100 comprises a client-server system that employs a client-server architecture, as shown in FIG. 1. However, the embodiments of the present disclosure are, of course, not limited to a client-server architecture, and could equally well find application in a distributed, or peer-to-peer, architecture system.

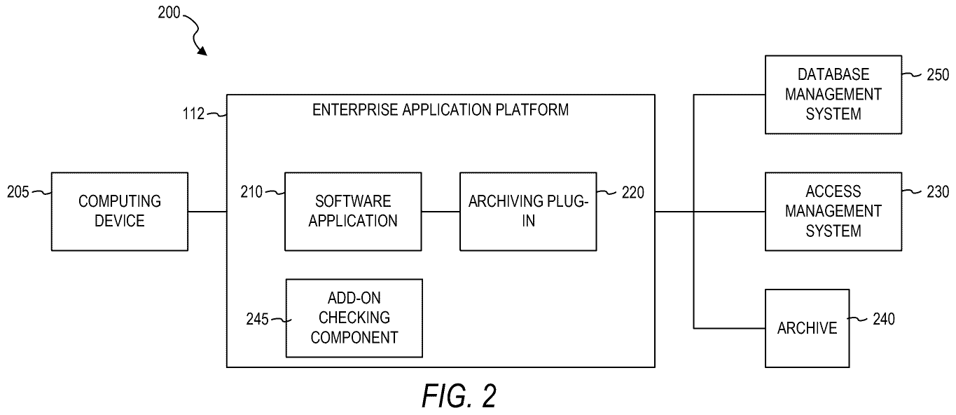

FIG. 2 is a block diagram illustrating an example archive access system 200, in accordance with an example embodiment. The archive access system 200 may be configured to implement access control for archived objects. In some example embodiments, the archive access system 200 may comprise any combination of one or more of a software application 210, an archiving plug-in 220, an access management system 230, and an archive 240. The components shown in FIG. 2 may be configured to communicate with each other via one or more network connections, such as via the network 114 in FIG. 1. In some example embodiments, one or more of the components of the archive access system 200 may be implemented by the enterprise application platform 112 of FIG. 1. For example, the software application 210 and the archiving plug-in 220 may be incorporated into the enterprise application platform 112. The access management system 230 and the archive 240 may also be incorporated into the enterprise application platform 112, or, alternatively, may be incorporated into a separate computer system.

The software application 210 may comprise an enterprise application. An enterprise application is a large software system platform designed to operate in an organization, such as business or government. Enterprise applications may comprise a group of programs with shared business applications and organizational modeling utilities, and they may be developed using enterprise architecture. Enterprise applications may be configured to provide services including, but not limited to, online shopping and payment processing, interactive product catalogs, computerized billing systems, content management, information technology service management, enterprise resource planning, business intelligence, human resource management, manufacturing, application integration, forms automation, sales force automation, and business process management.

In some example embodiments, the software application 210 may be configured to create objects, such as in response to instructions or input provided by a user of a computing device 205 accessing the software application 210. The objects may comprise entities within a multi-tiered software application that works in conjunction with data access and domain logic layers to transport data. One example of such an object is a business object. A business object may comprise a container for application data, such as a customer or an invoice. Data may be exchanged between software components by business objects. A business object may contain fields that have a name, a type (e.g., a scalar type or another business object), a default value (e.g., for scalar types), and cardinality. Other types of objects are also within the scope of the present disclosure.

The data of objects created via the software application 210 may have an original format. For example, upon creation, the objects may have an Extensible Markup Language (XML) format or a JavaScript® Object Notation (JSON) format. Other types of formats are also within the scope of the present disclosure. The data of these objects may be stored in a database within a database management system 250. In some example embodiments, this data may be archived. For example, the database management system 250, or some other component of the archive access system 200, may move the data from the database of the database management system 250 to the archive 240. The archive 240 may comprise a storage device that is separate from the database of the database management system 250. The archived data may be stored in the archive 240 in a first format that is configured specifically for data archival. For example, the archived data may be stored in a binary large object (BLOB) format. BLOB is a data type that can store binary objects or data. BLOB may comprise a collection of binary data stored as a single entity. Other types of formats may be used for the first format of the archived data.

The archiving plug-in 220 may comprise a plug-in, or some other software component, that provides additional functionality to the software application 210. The archiving plug-in 220 may enable effective and efficient access control to the archive 240. By connecting the archiving plug-in 220 to the software application 210, the access management system 230, and the archive 240, the archive access system 200 provides secure access to users of the software application to the contents of the archive 240.

In an example embodiment, an add-on code checking component 245 is added to the enterprise application platform 112. The add-on code checking component 245 acts to check add-on code in an object under certain circumstances and to sometime block execution of the add-on code.

More specifically, when the status of an object is changed to “InProcess”, indicating that the object is in the process of being archived, the add-on code checking component 245 blocks execution of any add-on code in or associated with the object. Later, when the status of the object is changed to “Archived”, indicating that the archiving of the object has been completed and the object is ready to be deleted, the add-on code checking component 245 continues to block add-on code in or associated with the object, except for add-on code that is set to trigger upon deletion of the object. Once the object is deleted, the add-on code that is set to trigger upon deletion of the object is executed.

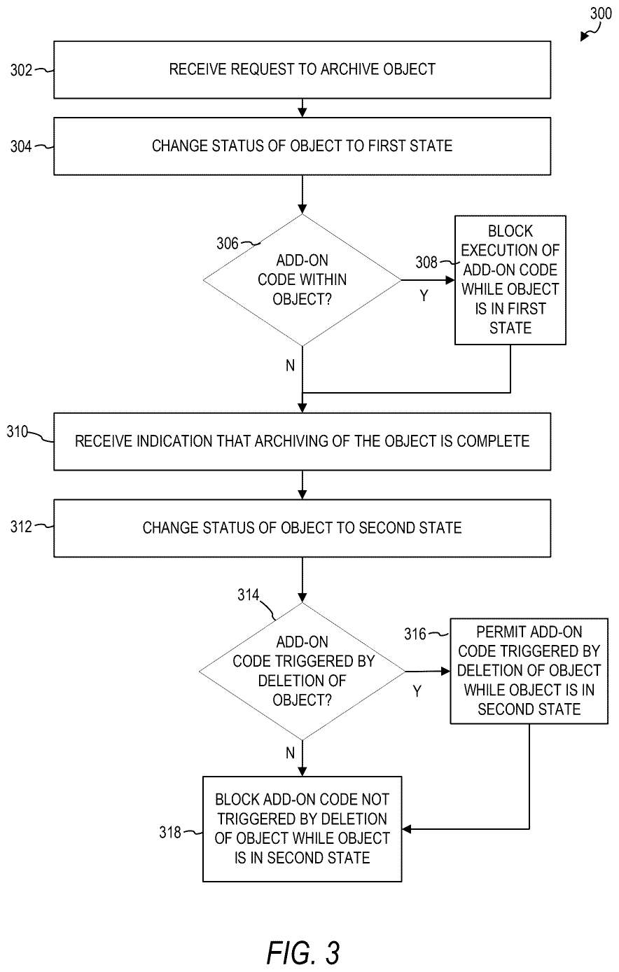

FIG. 3 is a flowchart illustrating an example method 300, in accordance with an example embodiment. The method 300 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 300 are performed by the archiving system 200 of FIG. 2 or any combination of one or more of its components.

At operation 302, a request to archive an object stored in a database is received. At operation 304, a status of the object is changed to a first state, the first state indicating that the object is being archived. At operation 306, it is determined if there is any add-on code within the object. If so, then at operation 308 execution of the add-on code is blocked while the status is set to the first state. Then, or if operation 306 determined that there was no add-on code within the object, at operation 310 an indication that archiving of the object has been completed is received. At operation 312, the status of the object is set to a second state, the second state indicating that the object has been archived. At operation 314, it is determined if there is any add-on code within the object that is designed to trigger upon deletion of the object. If so, then at operation 316, execution of the add-on code within the object that is designed to trigger upon deletion of the object is permitted, while the status in set to the second state. At operation 318, execution of any add-on code within the object other than add-on code that is designed to trigger upon deletion of the object is blocked, while the status in set to the second state.

In view of the disclosure above, various examples are set forth below. It should be noted that one or more features of an example, taken in isolation or combination, should be considered within the disclosure of this application.

Example 1 is a system comprising: at least one hardware processor; a non-transitory computer-readable medium storing instructions that, when executed by the at least one hardware processor, cause the at least one hardware processor to perform operations comprising: receiving a request to archive an object stored in a database; changing a status of the object to a first state, the first state indicating that the object is being archived; blocking execution of any add-on code within the object while the status is set to the first state; upon completion of archiving of the object, setting the status of the object to a second state, the second state indicating that the object has been archived; allowing execution of add-on code within the object that is designed to trigger upon deletion of the object, while the status in set to the second state; and blocking execution of all add-on code within the object other than the add-on code that is designed to trigger upon deletion of the object, while the status in set to the second state.

In Example 2, the subject matter of Example 1 includes, wherein the add-on code includes a call to an external service.

In Example 3, the subject matter of Examples 1-2 includes, wherein operations are performed by a cloud service and the add-on code is specified by a customer of the cloud service.

In Example 4, the subject matter of Examples 1-3 includes, wherein the add-on code is stored in a field in the object.

In Example 5, the subject matter of Examples 3-4 includes, wherein the archiving is performed by an archiving component outside of the cloud service.

In Example 6, the subject matter of Examples 3-5 includes, wherein the object is in JavaScript Object Notation (JSON) format.

In Example 7, the subject matter of Example 6 includes, wherein the add-on code is in Abseil (ABSL) format.

Example 8 is a method comprising: receiving a request to archive an object stored in a database; changing a status of the object to a first state, the first state indicating that the object is being archived; blocking execution of any add-on code within the object while the status is set to the first state; upon completion of archiving of the object, setting the status of the object to a second state, the second state indicating that the object has been archived; allowing execution of add-on code within the object that is designed to trigger upon deletion of the object, while the status in set to the second state; and blocking execution of all add-on code within the object other than the add-on code that is designed to trigger upon deletion of the object, while the status in set to the second state.

In Example 9, the subject matter of Example 8 includes, wherein the add-on code includes a call to an external service.

In Example 10, the subject matter of Examples 8-9 includes, wherein operations are performed by a cloud service and the add-on code is specified by a customer of the cloud service.

In Example 11, the subject matter of Examples 8-10 includes, wherein the add-on code is stored in a field in the object.

In Example 12, the subject matter of Examples 10-11 includes, wherein the archiving is performed by an archiving component outside of the cloud service.

In Example 13, the subject matter of Examples 10-12 includes, wherein the object is in JavaScript Object Notation (JSON) format.

In Example 14, the subject matter of Example 13 includes, wherein the add-on code is in Abseil (ABSL) format.

Example 15 is a non-transitory machine-readable medium storing instructions which, when executed by one or more processors, cause the one or more processors to perform operations comprising: receiving a request to archive an object stored in a database; changing a status of the object to a first state, the first state indicating that the object is being archived; blocking execution of any add-on code within the object while the status is set to the first state; upon completion of archiving of the object, setting the status of the object to a second state, the second state indicating that the object has been archived; allowing execution of add-on code within the object that is designed to trigger upon deletion of the object, while the status in set to the second state; and blocking execution of all add-on code within the object other than the add-on code that is designed to trigger upon deletion of the object, while the status in set to the second state.

In Example 16, the subject matter of Example 15 includes, wherein the add-on code includes a call to an external service.

In Example 17, the subject matter of Examples 15-16 includes, wherein operations are performed by a cloud service and the add-on code is specified by a customer of the cloud service.

In Example 18, the subject matter of Examples 15-17 includes, wherein the add-on code is stored in a field in the object.

In Example 19, the subject matter of Examples 17-18 includes, wherein the archiving is performed by an archiving component outside of the cloud service.

In Example 20, the subject matter of Examples 17-19 includes, wherein the object is in JavaScript Object Notation (JSON) format.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Certain embodiments are described herein as comprising logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

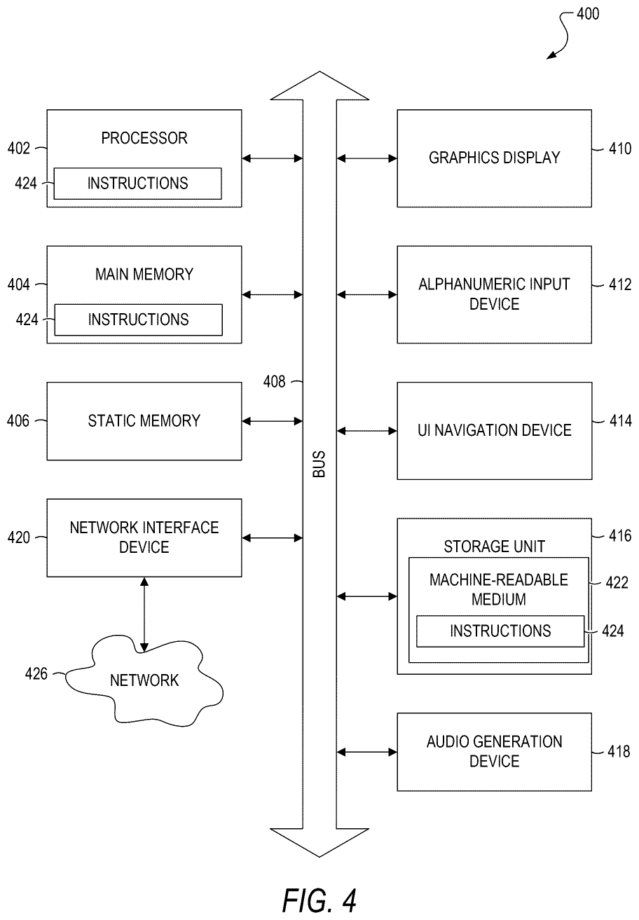

FIG. 4 is a block diagram of a machine in the example form of a computer system 400 within which instructions 424 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404, and a static memory 406, which communicate with each other via a bus 408. The computer system 400 may further include a graphics or video display unit 410 (e.g., a liquid crystal display (LCD) or a cathode ray tube [CRT]). The computer system 400 also includes an alphanumeric input device 412 (e.g., a keyboard), a user interface (UI) navigation (or cursor control) device 414 (e.g., a mouse), a storage unit (e.g., a disk drive unit) 416, an audio or signal generation device 418 (e.g., a speaker), and a network interface device 420.

The storage unit 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media. The instructions 424 may also reside, completely or at least partially, within the static memory 406.

While the machine-readable medium 422 is shown in an example embodiment to be a single medium, the term “machine-readable medium” may include a single medium or multiple media (e.g., a centralized or distributed database, and/or associated caches and servers) that store the one or more instructions 424 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a LAN, a WAN, the Internet, mobile telephone networks, POTS networks, and wireless data networks (e.g., WiFi and WiMAX networks). The term “transmission medium” shall be taken to include any intangible medium capable of storing, encoding, or carrying instructions for execution by the machine, and includes digital or analog communications signals or other intangible media to facilitate communication of such software.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
at least one hardware processor;
a non-transitory computer-readable medium storing instructions that, when executed by the at least one hardware processor, cause the at least one hardware processor to perform operations comprising:
receiving a request to archive an object stored in a database;
changing a status of the object to a first state, the first state indicating that the object is being archived;
blocking execution of any add-on code within the object while the status is set to the first state;
upon completion of archiving of the object, setting the status of the object to a second state, the second state indicating that the object has been archived;
allowing execution of add-on code within the object that is designed to trigger upon deletion of the object, while the status in set to the second state; and
blocking execution of all add-on code within the object other than the add-on code that is designed to trigger upon deletion of the object, while the status in set to the second state.

2. The system of claim 1, wherein the add-on code includes a call to an external service.

3. The system of claim 1, wherein operations are performed by a cloud service and the add-on code is specified by a customer of the cloud service.

4. The system of claim 1, wherein the add-on code is stored in a field in the object.

5. The system of claim 3, wherein the archiving is performed by an archiving component outside of the cloud service.

6. The system of claim 3, wherein the object is in JavaScript Object Notation (JSON) format.

7. The system of claim 6, wherein the add-on code is in Abseil (ABSL) format.

8. A method comprising:
receiving a request to archive an object stored in a database;
changing a status of the object to a first state, the first state indicating that the object is being archived;
blocking execution of any add-on code within the object while the status is set to the first state;
upon completion of archiving of the object, setting the status of the object to a second state, the second state indicating that the object has been archived;
allowing execution of add-on code within the object that is designed to trigger upon deletion of the object, while the status in set to the second state; and
blocking execution of all add-on code within the object other than the add-on code that is designed to trigger upon deletion of the object, while the status in set to the second state.

9. The method of claim 8, wherein the add-on code includes a call to an external service.

10. The method of claim 8, wherein operations are performed by a cloud service and the add-on code is specified by a customer of the cloud service.

11. The method of claim 8, wherein the add-on code is stored in a field in the object.

12. The method of claim 10, wherein the archiving is performed by an archiving component outside of the cloud service.

13. The method of claim 10, wherein the object is in JavaScript Object Notation (JSON) format.

14. The method of claim 13, wherein the add-on code is in Abseil (ABSL) format.

15. A non-transitory machine-readable medium storing instructions which, when executed by one or more processors, cause the one or more processors to perform operations comprising:
receiving a request to archive an object stored in a database;
changing a status of the object to a first state, the first state indicating that the object is being archived;
blocking execution of any add-on code within the object while the status is set to the first state;
upon completion of archiving of the object, setting the status of the object to a second state, the second state indicating that the object has been archived;
allowing execution of add-on code within the object that is designed to trigger upon deletion of the object, while the status in set to the second state; and
blocking execution of all add-on code within the object other than the add-on code that is designed to trigger upon deletion of the object, while the status in set to the second state.

16. The non-transitory machine-readable medium of claim 15, wherein the add-on code includes a call to an external service.

17. The non-transitory machine-readable medium of claim 15, wherein operations are performed by a cloud service and the add-on code is specified by a customer of the cloud service.

18. The non-transitory machine-readable medium of claim 15, wherein the add-on code is stored in a field in the object.

19. The non-transitory machine-readable medium of claim 17, wherein the archiving is performed by an archiving component outside of the cloud service.

20. The non-transitory machine-readable medium of claim 17, wherein the object is in JavaScript Object Notation (JSON) format.
